(19) United States
(12) Patent Application Publication
(10) Pub. No.: US 2022/0226880 A1
(43) Pub. Date: Jul. 21, 2022

(54) METHOD FOR MAKING A SPRING CORE FOR A MATTRESS OR FOR SEATING PRODUCTS

(71) Applicant: NV BEKAERT SA, Zwevegem (BE)

(72) Inventor: Bert VANDERBEKEN, Waregem (BE)

(73) Assignee: NV BEKAERT SA, Zwevegem (BE)

(21) Appl. No.: 17/608,522

(22) PCT Filed: Mar. 26, 2020
(86) PCT No.: PCT/EP2020/058456

§ 371 Date: Nov. 3, 2021

(30) Foreign Application Priority Data
May 20, 2019 (EP) 19175297.1

(51) Int. Cl. B21F 27/16; C21D 9/02; C21D 8/00; C21D 6/00; C22C 38/18; C22C 38/02; C22C 38/06; B21F 33/04; B68G 9/00

(52) U.S. Cl. CPC B21F 27/16; C21D 9/02; C21D 8/005; C21D 6/008; B68G 9/00; C22C 38/18; C22C 38/02; C22C 38/06; B21F 33/04; C21D 6/002

(57) ABSTRACT

A method to manufacture a steel wire spring core for a mattress or for seating is described, which comprises the steps of providing a carrier comprising steel wire; repeatedly cold coiling a steel wire spring from steel wire taken from the carrier; and connecting a series of the coiled steel wire springs to each other. The steel wire has a diameter d between 0.8 and 4.5 mm; and has a drawn pearlitic microstructure. The steel wire comprises a steel alloy having a carbon content between 0.35 wt % and 0.85 wt %. The steel wire on the carrier has a ratio—expressed as a percentage—of the yield strength R_{po 2} (in MPa) over the tensile strength Rₘ (in MPa) higher than 85%.

### TECHNICAL FIELD

The invention relates to methods for making a steel wire spring core for mattresses or for seating. The steel wire spring core can e.g. be a pocketed spring core, a Bonnell spring core, an LFK spring core or a continuous wire spring core.

### BACKGROUND ART

Different types of steel wire spring cores are known for use in mattresses or in seating such as sofas. Examples of steel wire spring cores are pocketed spring cores, Bonnell spring cores, LFK spring cores and continuous wire spring cores.

WO98/53933 describes a method and apparatus for forming a length of connected, pocketed coil springs for use in mattresses and the like. On the apparatus, steel wire from a supply source is heated to between 232° C. and 260° C. by an induction heater, hot coiled, severed and cooled below a temperature where a permanent set might occur from further processing of the spring. Thereafter, the spring is compressed in preparation for its insertion into a space provided by stretchable fabric from a supply reel. The fabric is folded on itself to provide the space. The temperature of the spring must also be sufficiently low to contact the fabric without causing burns or other damage. After insertion of a compressed spring into the space, the fabric is ultrasonically welded to create individual but connected pockets for each spring. Thereafter, the springs are oriented to allow each spring to expand thereby creating the length of connected, pocketed coil springs.

GB2347638A discloses mattress spring units which are manufactured by forming a plurality of spring elements from a roll of steel wire. Rows of the spring elements are secured together by lengths of helical wire until the desired size of spring unit is formed. The formed spring unit is transferred to an oven where it is tempered. Following cooling in air the spring units are either formed into a roll or bands are attached to the outer spring elements. During the tempering process, the overall height of the spring elements is reduced.

WO96/05109A1 discloses a method for producing pocketed coil springs for use in innerspring constructions. The method comprises the steps of forming coil springs from spring wire at a first temperature—wherein the spring wire has inherent residual stresses-; conditioning the coil springs at a second temperature sufficient to substantially reduce the inherent residual stresses in the spring wire of the coil springs; adjusting the temperature of the conditioned coil springs to a third temperature sufficient to enable insertion of the conditioned coil springs into a fabric pocket; and inserting the coil springs into a fabric pocket.

### DISCLOSURE OF INVENTION

The invention is a method to manufacture a steel wire spring core for a mattress or for seating. The method comprises the steps of providing a carrier comprising steel wire; repeatedly cold coiling a steel wire spring from steel wire taken from the carrier; and connecting a series of the coiled steel wire springs to each other. Preferably, the steel wire spring is a helically coiled steel wire spring. The steel wire has a diameter d between 0.5 and 4.5 mm. The steel wire comprises a steel alloy having a carbon content between 0.35 wt % and 0.85 wt %. The steel wire has a drawn pearlitic microstructure. The steel wire on the carrier has a ratio—expressed as a percentage—of the yield strength R_{p0.2} (in MPa) over the tensile strength Rₘ (in MPa) higher than 85%, preferably higher than 87%, even more preferably higher than 90%, even more preferably higher than 92%, even more preferably higher than 93%. The mechanical properties Rₘ and R_{p0.2} are defined and tested according to ISO 6892-1:2016. The tensile strength Rₘ is the maximum stress (in MPa) in tensile testing. The yield strength R_{p0.2} (in MPa) is the stress when crossing the tensile curve with the line through 0.2% strain and parallel with the elastic modulus line. The ratio R_{p0.2}/Rₘ is the value for R_{p0.2} (in MPa), divided by the value for Rₘ (in MPa) and expressed as a percentage.

With cold coiling is meant that the coiling is performed at room temperature, it means that the wire is not heated for coiling the steel wire spring.

The use of the specific steel wire properties of the steel wire on the carrier for coiling the steel wire springs ensures that a steel wire spring is made at high speeds in a reliable and constant way that has low or no relaxation when used in a steel wire spring core in a mattress or in a seating product. As a consequence, local permanent deformation of the spring core will be low when used in mattresses of in seating products.

Use of the carrier comprising the steel wire as in the invention eliminates the need to perform special heat treatments on the spring coiling machine before or after spring coiling or on the steel wire spring core to reduce local permanent deformation of the steel wire spring cores in use in mattresses or seating products. (Special) Heat treatments on the steel wire on the spring coiling machine or on the coiled steel spring on the spring coiling machine cannot be done in a reliable and constant way, also because of the increased speeds of spring coiling.

The use of cold coiling for making the springs enables that the springs are coiled at high speeds, as the steel wire does not require to be heated on the spring coiling machine.

The textile cloth—normally a polymer fiber nonwoven fabric—of pocketed spring cores is not sufficiently temperature resistant to resist a thermal aftertreatment on pocketed spring cores to reduce or eliminate relaxation of the steel wire springs of pocketed spring cores.

The steel wire used in the method of the invention can be produced by drawing a steel wire starting from a steel wire rod. Drawn steel wires having a microstructure of drawn lamellar pearlite typically have an R_{p0.2} value about 70-75% of the tensile strength Rₘ. By a heat treatment on the steel wire at temperatures between 200 and 300° C., the R_{p0.2} value relative to the tensile strength Rₘ is increased up to the levels as specified in the invention. The heat treatment can be performed as an inline process at the end of wire drawing, or off-line in a batch process in a furnace.

Preferably, the steel alloy comprises more than 0.55 wt % C, even more preferably more than 0.6 wt % C. Even more preferably, the steel alloy comprises more than 0.7 wt % C. Such embodiments are particularly preferred. The higher carbon content of the steel alloy provides steel wires of higher strength (higher Rₘ values). The high relative R_{p0.2} values of steel wires used in the invention means that the absolute value of the R_{p0.2} is even higher in such embodiments. This is favorable for the invention as mattress spring cores with even lower relaxation of the springs are provided.

Preferably, the elongation at breakage in tensile testing of the steel wire is higher than 3%.

Preferably, the steel alloy comprises between 0.1 and 1.4 wt % Si; and preferably less than 0.8 wt % Si; more preferably less than 0.3 wt % Si.

Optionally, the steel alloy can comprise micro-alloying elements in individual amounts less than 0.5 wt %; even more preferably in individual amounts less than 0.3 wt %. Examples of such micro-alloying elements are Cr, W, V, Mo, Ti, Nb.

The steel alloy further comprises unavoidable impurities: preferably, phosphorous is limited to 0.035 wt %, preferably sulphur is limited to less than 0.035 wt %, preferably aluminum is limited to less than 0.1 wt %; and preferably copper is limited to less than 0.2 wt %.

In preferred embodiments, the steel alloy does not comprise—beyond impurity levels—any one of the following micro-alloying elements Cr, W, V, Mo, Ti, Nb. The steel wire further comprises unavoidable impurities: preferably, phosphorous is limited to 0.035 wt %, sulphur is limited to less than 0.035 wt %, aluminum is limited to less than 0.1 wt %; and copper is limited to less than 0.2 wt %. In a more preferred embodiment, the steel alloy comprises Mn and Si; and the balance of the composition of the steel alloy is iron.

Preferably, the steel wire has a diameter ranging between 1.6 mm and 2.5 mm.

Preferably, the steel wire has a diameter higher than 1.7 mm.

Preferably, the steel wire has a diameter less than 2.3 mm.

Preferably, the steel wire has a diameter between 1.7 mm and 2.3 mm.

In a preferred method, the steel alloy comprises between 0.2 and 0.9 wt % Mn; more preferably more than 0.4 wt % Mn.

Preferably, the steel alloy comprises between 1.3 and 1.6 wt % Si and between 0.6 and 0.9 wt % Cr. More preferably, the steel alloy consists out of between 0.35 and 0.85 wt % C, between 1.3 and 1.6 wt % Si, between 0.6 and 0.9 wt % Cr, unavoidable impurities and the remainder being iron.

In a preferred method, the carrier is a bobbin onto which the steel wire is wound. Such method is preferred, as the use of other carriers could have a negative effect on the mechanical properties of the steel wire on the carrier. As an example, the use of a spider is less preferred as the steel wire needs to be deformed in order to put the steel wire on the spider, such deformation can negatively affect the mechanical properties of the steel wire relevant for compression springs.

In a preferred method, the steel alloy of the steel wire comprises between 0.02 and 0.06 wt % aluminum. Such method is preferred, as spring coiling is improved because the presence of aluminum in the steel alloy improves the ductility of the steel wire.

In a preferred method, more than 120 steel wire springs are manufactured per minute.

Preferably, the tensile strength Rₘ (in MPa) of the steel wire is higher than the value obtained via the formula 2200−390.71*ln(d); d being the diameter of the steel wire in mm, and ln(d) is the natural logarithm of the diameter d in mm. More preferably, the diameter of the steel wire in such embodiments is less than 1.7 mm; even more preferably less than 1.6 mm. For the sake of clarity a calculation example is given: for a steel wire of 1.5 mm diameter, the formula 2200−390.72*ln(1.5) results in 2041.6 MPa.

Preferably, the tensile strength Rₘ (in MPa) of the steel wire is less than the value obtained via the formula 2450−390.71*ln(d); wherein d is the diameter of the steel wire in mm.

In a preferred method, the steel wire does not comprise a metallic coating layer. In case of no metallic coating, the steel wire is preferably provided with an oil or wax in order to protect against corrosion.

In an alternative preferred method, the steel wire is provided with a metallic coating. Preferably the metallic coating comprises or consists out of zinc; or comprises at least 84% by weight of zinc and optionally aluminum. More preferably the microstructure of the metallic coating comprises a globularized aluminum rich phase. Such globularized aluminum rich phase is particularly created when heat treatment is performed on the steel wire, whether the heat treatment is performed inline (meaning in a continuous operation) or in a batch process. It is believed that the globularized aluminum rich phase improves the corrosion resistance of the metallic coating layer; such that a thinner metallic coating layer can be used while still having corrosion protection.

Preferably when the steel wire comprises a metallic coating, the amount of metallic coating is less than 120 g/m², more preferably less than 80 g/m², even more preferably less than 60 g/m².

Viewed from an alternative and general aspect, the invention aims at saving weight in steel wire spring cores for mattress or seating that still exhibit low relaxation properties.

The following formula determines the spring rate R of a steel spring:

R=G×d⁴/(8Nₐ×Dₘ³)

where
d is the wire diameter
Dₘ is the spring diameter
Nₐ is the number of coils
G is the shear modulus.

So the stiffness of a spring is proportional to the fourth power of the wire diameter and inversely proportional to the number of coils.

With a view of saving weight one may decrease the wire diameter. In order to keep the spring rate R at the same level for a spring with the same diameter and height, the number of coils Nₐ has to be decreased. The decreased number of coils Nₐ leads to a reduced length of the steel wire in the spring. So the effect on weight saving is double: a thinner diameter steel wire and a shorter length of the steel wire. For a same amount of compression of the spring, however, the steel wire is subjected to a higher degree of torsions due to the reduced number of coils Nₐ. Due to this higher torsion degree, the steel wire risks to flow quicker in the plastic region. So the steel wires must exhibit a higher yield strength to avoid the plastic deformation and to guarantee multiple bouncing back of the steel springs.

The yield strength R_{p0.2} of the steel wires expressed in MPa is preferably higher than the value obtained by the formula 1870−332.10×ln(d), and most preferably higher than the value obtained by the formula 1980−351.63×ln(d), where d is the wire diameter expressed in mm.

Pocketed Spring Cores Made from Linear Strings of Pocketed Springs

In a preferred method, connecting a series of the coiled steel wire springs to each other is performed by inserting the coiled steel wire springs in compressed state in pockets made from a cloth. A linear string of pocketed springs is obtained. In such embodiments, pocketed spring cores are made. More preferably, the pockets of the linear string of pocketed springs are formed from a single piece of cloth. Even more preferably, the pockets are closed and a linear string of pocketed springs is obtained. A spring core unit for a mattress can be made by connecting (preferably by gluing) linear strings of the pocketed springs parallel to each other. It is a benefit of this preferred method—wherein connecting a series of the coiled steel wire springs to each other is performed by inserting the coiled steel wire springs in compressed state in pockets made from a cloth—that lighter steel wire springs cores can be made. In the prior art, the springs are compressed and put in the pockets. The free height of the springs (this is the height when no compressive load is exerted on the springs) of prior art pocketed spring cores is more than the height of the pocket. The consequential pre-compression of the springs in the pockets helps to prevent the occurrence of permanent compressional deformation of the mattresses made with the spring cores. As in the invention the springs are less prone to permanent compressional deformation, less pre-compression of the springs in the pockets is required, and thus the free height of the spring can be lower resulting in a lighter pocketed spring core.

Pocketed Spring Cores Directly Made with a Two-Dimensional Matrix OF Pocketed Springs—More Specifically the so-Called “Microcoil” Spring Cores or “Nanocoil” Spring Cores

In a preferred method, a two-dimensional matrix of coiled steel wire springs is provided. The coiled steel wire springs are encased in pockets. The plane of the two-dimensional matrix is perpendicular to the longitudinal axes of the coiled steel wire springs. The pockets are formed by a first fabric ply on top of the coiled steel wire springs, by a second fabric ply below the coiled steel wire springs and by seams between the first fabric ply and the second fabric ply. The seams surround the coiled steel wire spring. Preferably, the first fabric ply and the second fabric ply are fabrics out of thermoplastic fibers; more preferably nonwoven fabrics out of thermoplastic fibers; e.g. spunbonded nonwoven fabrics. Preferably, the welds are welded seams, thermally bonding the thermoplastic first fabric ply to the thermoplastic second fabric ply.

Preferably, such steel wire spring core has a height less than 6 cm, more preferably less than 5 cm and even more preferably less than 4 cm.

In this preferred method, the steel wire diameter is preferably less than 1 mm, e.g. 0.8 mm.

Such methods are especially of interests when steel wire spring cores of low height (e.g. less than 5 cm height) are made. In this preferred method, a spring core of low height but that has no or low relaxation can be made.

In a more preferred such method, more than 200 springs are manufactured per minute.

It is an advantage of the embodiments of these preferred methods that spring cores of small height can be manufactured that can be used as comfort layer of a mattress, on top of another spring core, e.g. of a pocketed spring core. Such comfort layer made according to the invention is breathable and elastic in multiple directions, with limited or even no relaxation. It is meant that limited or no permanent deformation of the springs will occur when using the spring core. The high speeds of manufacturing the steel wire springs and specific fabric selection (most of time out of polymer fiber nonwoven fabrics) make it virtually impossible to perform heating operations on the steel wire or on the coiled steel wire springs on the spring manufacturing machine and/or on the spring core manufacturing machine.

In an embodiment, the first fabric ply and the second fabric ply can be two distinct fabrics.

In another embodiment the first fabric ply and the second fabric ply can be one fabric folded over.

### Bonnell or LFK Type Spring Cores

A preferred method comprises the step of connecting the coiled springs to each other by lacing a steel wire through the coiled springs. More preferably, the springs are individually coiled and provided as discrete parts to the operation wherein the steel wire is laced through the coiled springs to interconnect them. This way, “Bonell” type or “LFK” type spring cores can be produced.

In a preferred embodiment, the coiled springs have at both of their ends a knot provided by the steel wire from which the springs are coiled, knotting the steel wire to itself in the spring. More preferably, a steel wire is laced through the coiled springs to connect the coiled springs to each other. This way, a Bonell type spring core can be made.

In a preferred embodiment, the coiled springs do not have at either end a knot provided by the steel wire from which the springs are coiled. More preferably, a steel wire is laced through the coiled springs to connect the coiled springs to each other. This way, LFK type spring cores can be made.

### Continuous Wire Spring Cores

In a preferred embodiment, a multitude of steel wire springs are coiled without cutting the steel wire such that the steel wire runs continuously through the multitude of steel wire springs in the spring core. This way, a continuous-coil type spring core for a mattress or for seating is manufactured. Optionally, an additional lacing wire can be used to improve the interconnection between the steel wire springs.

### BRIEF DESCRIPTION OF FIGURES IN THE DRAWINGS

FIG. 1 illustrates the tensile stress-strain curve of a steel wire.

FIG. 2 shows a pocketed spring mattress core as can be made using the method of the invention.

FIG. 3 shows an example of a Bonnell spring.

FIG. 4 shows a Bonnell spring core for a mattress, as can be made using the method of the invention.

FIG. 5 shows an example of an LFK spring.

FIG. 6 shows an LFK spring core for a mattress, as can be made using the method of the invention.

FIG. 7 shows a continuous spring, as can be made using the method of the invention.

FIG. 8 shows another type of steel wire spring core wherein the steel wire spring are encased in fabric pockets.

### MODE(S) FOR CARRYING OUT THE INVENTION

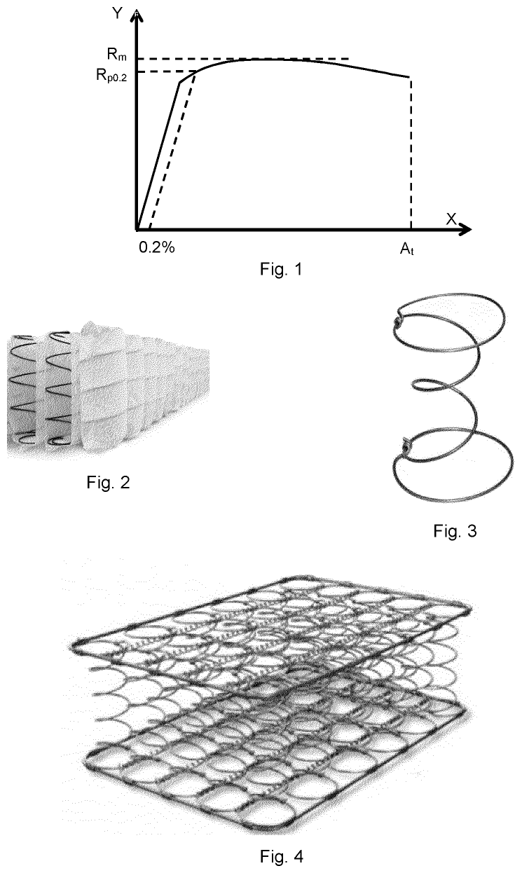

FIG. 1 provides information about the way the mechanical properties of the steel wires are described in this document. The mechanical properties are described and tested according to ISO 6892-1:2016 (which is entitled “Metallic materials—Tensile testing—Part 1: Method of test at room temperature”). FIG. 1 schematically illustrates a stress-strain curve of a steel wire in an uniaxial tensile test. In the X-axis, the strain is provided. The vertical (Y) axis provides the tensile stress (in MPa). The elongation at breakage is represented by Aₜ. The tensile strength Rₘ is the maximum stress. The yield strength R_{p0.2} is the stress when crossing the tensile curve with the line through 0.2% strain and parallel with the elastic modulus line.

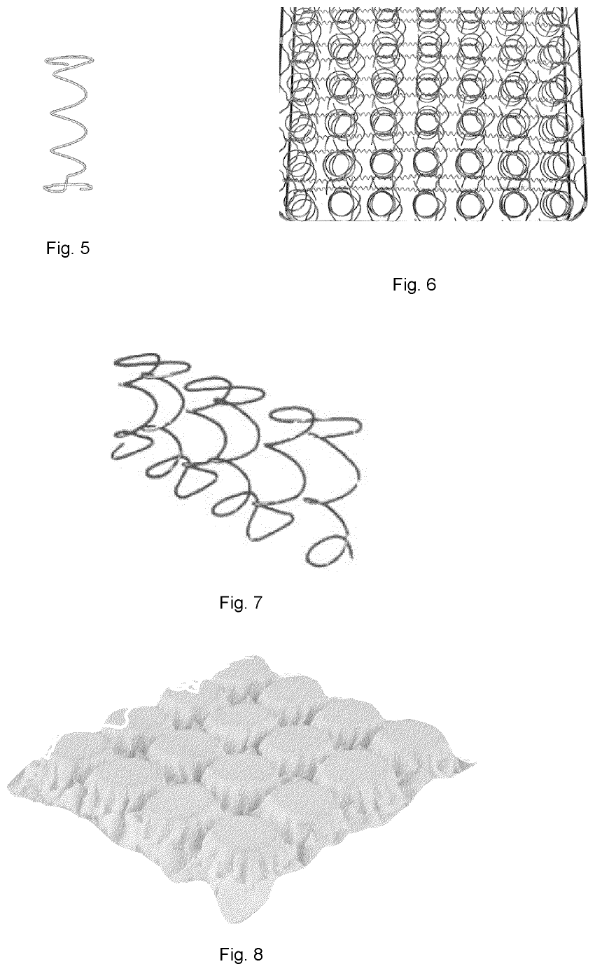

FIG. 2 shows a pocketed spring mattress core as can be made using the method of the invention. FIG. 3 shows an example of a Bonnell spring. FIG. 4 shows a Bonnell spring core for a mattress, as can be made using the method of the invention. FIG. 5 shows an LFK spring. FIG. 6 shows an LFK spring core for a mattress, as can be made using the method of the invention. FIG. 7 shows a continuous spring as can be used to manufacture a mattress core using the method of the invention.

FIG. 8 shows another type of steel wire spring core wherein the steel wire springs are encased in fabric; and that can be made with a method according to the invention. The steel wire springs are positioned in a two dimensional matrix. On top and below the two dimensional array of steel wire springs a nonwoven fabric is provided. The pockets are formed by a first nonwoven fabric on top of the coiled steel wire springs, by a second nonwoven fabric below the coiled steel wire springs and by seams between the first nonwoven fabric and the second nonwoven fabric. The seams surround the coiled steel wire springs. The seams can be established by thermal welds (e.g. made by means of ultrasonic welding equipment) bonding the two nonwoven fabrics to each other.

A first series of experiments related to pocketed spring cores for mattresses. A 2 mm diameter steel wire was used, made out of a steel alloy consisting out of between 0.71 and 0.75 wt % carbon, between 0.6 and 0.9 wt % manganese, at maximum 0.03 wt % aluminum; unavoidable impurities, and the balance being iron. A 2 mm diameter steel wire has been drawn starting from a wire rod of 5.5 mm diameter. The tensile properties of the steel wire have been tested according to ISO 6892-1:2016: tensile strength Rₘ=2018 MPa, R_{p0.2}=1507 MPa (meaning that the R_{p0.2} is 75% of the tensile strength Rₘ), and elongation at breakage=3%. A bobbin of steel wire has been treated in a furnace at 300° C. during 2 hours. After this heat treatment, the tensile properties have been tested again: tensile strength Rₘ=2052 MPa, R_{p0.2}=1823 MPa (meaning that the R_{p0.2} is 89% of the tensile strength Rₘ), elongation at break 7%.

Helically coiled springs have been made according to the pocketed spring design with the steel wire that had been treated in the furnace as described in the previous paragraph. The spring height was 210 mm, the springs had diameter 80 mm and the springs had 7 coils. The springs have been tested according to Brazilian standard ABNT 15413-1:2013; entitled “Spring mattress and bases—part 1: Requirements and test methods”. This part of ABNT NBR 15413 establishes the requirements and test methods for spring mattresses and bases. The test method described in this standard involves compressing a single spring by hand to full compression during 10 seconds. After removing the load and allowing the spring to recover, a new compression cycle by hand to full compression is performed during 10 seconds. After removing the load and allowing the spring to recover, a new compression cycle by hand to full compression is performed during 60 seconds. After removal of the load, the loss of height of the spring compared to its initial height is measured and expressed as a percentage of the initial height of the spring. A maximum height loss of 8% is accepted according to this Brazilian standard. This test performed on the helically coiled springs with the steel wire that had been subjected to the thermal treatment showed no height loss.

The fatigue resistance of the spring cores made according to the method of the invention have been tested: the outcome is that the helically springs made with steel wire that has been subjected to the heat treatment are highly resistant to fatigue resistance.

A second series of tests related to steel wires for making Bonnell spring cores. A 2.2 mm diameter steel wire was made out of a steel alloy consisting out of between 0.55 and 0.59 wt % carbon and between 0.6 and 0.9 wt % manganese, at maximum 0.03 wt % aluminum; and unavoidable impurities, the balance being iron. The steel wire was drawn to 2.2 mm diameter starting from a wire rod of 5.5 mm diameter. The tensile properties of the steel wire have been tested according to ISO 6892-1:2016: tensile strength Rₘ=1415 MPa, R_{p0.2}=1050 MPa (meaning that the R_{p0.2} is 74.2% of the tensile strength Rₘ), and elongation at breakage=3.25%. Bobbins of steel wire have been treated in a furnace at different temperatures during one hour. After this heat treatment, the tensile properties have been tested again, the results are given in table I. The first column of table I indicates the temperature at which the heat treatment in the furnace has been performed.

TABLE I
Tensile test results of steel wire from heat treated bobbin

| Temperature | Rₘ | R_{p0.2} | R_{p0.2}/Rₘ | Elongation |
|---|---|---|---|---|
| (° C.) | (MPa) | (MPa) | (%) | (%) |
| 200 | 1507 | 1427 | 94.7 | 1.5 |
| 220 | 1526 | 1453 | 95.2 | 2 |
| 240 | 1547 | 1465 | 94.7 | 2 |
| 260 | 1557 | 1449 | 93.1 | 3.5 |
| 280 | 1525 | 1420 | 93.2 | 2.5 |
| 300 | 1517 | 1427 | 94.0 | 5 |

The table hereunder illustrates how the invention may be applied to realize weight savings in steel wire spring cores for mattresses or for seating.

TABLE II

| | | | |
|---|---|---|---|
| Wire diameter (mm) | d | 2 | 1.8 |
| Minimum tensile strength (Mpa) | Rₘ | 1800 | 1800 |
| Spring outer diameter (mm) | Dₒᵤₜₑᵣ | 65 | 65 |
| Free length of spring (mm) | L_{free} | 160 | 160 |
| Solid height (mm) | L_{solid} | 14 | 9 |
| Max. Working length (mm) | Lₙ | 35.9 | 31.7 |
| Number of active coils | Nₐ | 6 | 4 |
| Spring index | C | 31.5 | 35.1 |
| Wahl correction factor | W | 1.0 | 1.0 |
| Coil pitch (mm) | Pitsch | 26.3 | 39.6 |
| Rise angle (°) | Θ | 7.6 | 11.3 |
| Spring rate (N/mm) | R | 0.106 | 0.103 |
| Max. Load at solid height (N) | Fₘₐₓ | 15.5 | 15.6 |
| Max. Total shear stress (MPa) | Tₘₐₓ | 324.4 | 448.2 |
| Max. Working load (N) | F_{max load} | 13.2 | 13.3 |
| Max. Working shear stress (MPa) | T_{max load} | 275.8 | 380.9 |
| Max. Allowed shear stress (MPa) | T_{zul} | 1008 | 1008 |
| Safety margin on shear | | 3.11 | 2.25 |
| Max. Displacement possible (mm) | L_{def} | 146 | 151 |
| Required length to make the spring | L_{wire} | 1.6 | 1.2 |
| (mm) | | | |
| Mass of the spring (kg) | m_{spring} | 0.039 | 0.024 |

Following the results of Table II, 39% of weight savings are realized.

1. A method to manufacture a steel wire spring core for a mattress or for seating, comprising the steps of
providing a carrier comprising steel wire;
repeatedly cold coiling a steel wire spring from steel wire taken from the carrier, and
connecting a series of the coiled steel wire springs to each other;
wherein the steel wire has a diameter d between 0.5 and 4.5 mm;
wherein the steel wire comprises a steel alloy, wherein the steel alloy has a carbon content between 0.35 wt % and 0.85 wt %;
wherein the steel wire has a drawn pearlitic microstructure;
wherein the steel wire on the carrier has a ratio—expressed as a percentage—of the yield strength R_{p0.}2 (in MPa) over the tensile strength Rₘ (in MPa) higher than 85%.

2. The method according to claim 1, wherein the steel alloy has a carbon content higher than 0.6 wt %, preferably higher than 0.7 wt %.

3. The method according to claim 1, wherein the carrier is a bobbin onto which the steel wire is wound.

4. The method according to claim 1, wherein the steel alloy comprises between 1.3 and 1.6 wt % Si; and between 0.6 and 0.9 wt % Cr.

5. The method according to claim 4, wherein the steel alloy consists of between 0.35 and 0.85 wt % C, between 1.3 and 1.6 wt % Si, between 0.6 and 0.9 wt % Cr, unavoidable impurities and the remainder being iron.

6. The method according to claim 1, wherein the steel alloy comprises between 0.02 and 0.06 wt % aluminum.

7. The method according to claim 1, wherein more than 120 steel wire springs are manufactured per minute.

8. The method according to claim 1, wherein the tensile strength Rₘ (in MPa) of the steel wire is higher than the value obtained via the formula 2200−390.71*ln(d); wherein d is the diameter of the steel wire in mm.

9. The method according to claim 1, wherein the steel wire does not comprise a metallic coating layer.

10. The method according to claim 1, wherein the steel wire is provided with a metallic coating, preferably wherein the microstructure of the metallic coating comprises a globularized aluminum rich phase.

11. The method according to claim 1,
wherein connecting a series of the coiled steel wire springs to each other is performed by inserting the coiled steel wire swings in compressed state in pockets made from a cloth, wherein a linear string of pocketed springs is obtained.

12. The method according to claim 11, wherein the pockets are formed from one single piece of cloth and wherein pockets are closed and linearly bonded to each other by means of welded bonds.

13. The method according to claim 1, wherein a two-dimensional matrix of coiled steel wire springs is provided, wherein the plane of the two-dimensional matrix is perpendicular to the longitudinal axes of the coiled steel wire springs; wherein the coiled steel wire springs are encased in pockets; wherein the pockets are formed by a first fabric ply on top of the coiled steel wire springs, by a second fabric ply below the coiled steel wire springs and by seams between the first fabric ply and the second fabric ply, wherein the seams surround the coiled steel wire springs.

14. The method according to claim 1, comprising the step of connecting the coiled springs to each other by lacing a steel wire through the coiled springs.

15. The method according to claim 1, wherein a multitude of steel wire springs are coiled without cutting the steel wire such that the steel wire runs continuously through the multitude of steel wire springs in the spring core.
